(19) United States
(12) Patent Application Publication
(10) Pub. No.: US 2025/0157695 A1
(43) Pub. Date: May 15, 2025

(54) Module, Method and Structure for Transmitting Electronic Image Signals of MIPI Camera

(71) Applicant: INNODISK CORPORATION, New Taipei City (TW)

(72) Inventor: Jen-Chang CHEN, New Taipei City (TW)

(73) Assignee: INNODISK CORPORATION, New Taipei City (TW)

(21) Appl. No.: 18/907,716

(22) Filed: Oct. 7, 2024

Related U.S. Application Data
(60) Provisional application No. 63/597,416, filed on Nov. 9, 2023.

(30) Foreign Application Priority Data
May 28, 2024 (TW) 113119689

(51) Int. Cl. H01B 11/06; H01R 24/28; H01R 107/00

(52) U.S. Cl. CPC H01B 11/06; H01R 24/28; H01R 2107/00

(57) ABSTRACT

The invention discloses a module for transmitting an MIPI camera image signal, including an MIPI camera, a first connection device, a second connection device and a cable disposed between the first connection device and the second connection device. The MIPI camera is configured to generate the MIPI camera image signal. The first connection device includes a first USB Type-C connector and a first plurality of self-defined pins disposed within the first USB Type-C connector, and configured to be connected to a system host. The second connection device includes a second USB Type-C connector and a second plurality of self-defined pins disposed within the second USB Type-C connector, and configured to be connected to the MIPI camera. The cable includes at least 2 pairs of differential signal twisted wires configured to receive the MIPI camera image signal through the second plurality of self-defined pins.

### CROSS-REFERENCE TO RELATED APPLICATION AND CLAIM OF PRIORITY

The application claims the benefit of U.S. Provisional Patent Application No. 63/597,416 filed on Nov. 9, 2023 and Taiwan Patent Application No. 113119689 filed on May 28, 2024, which are fully incorporated by reference as if fully set forth.

### FIELD OF THE INVENTION

The present invention is related to an electronic module and methods, in particular a module, methods and structures for transmitting electronic image signals of an MIPI Camera.

### BACKGROUND OF THE INVENTION

Portable electronic devices such as mobile phones have become an indispensable communication tool for people in modern life. To meet the photography functions that are often needed in daily life, an interface called Mobile Industry Processor Interface (MIPI) that can be used in a processor of handheld devices (such as smartphones, tablets, laptops and hybrid devices) has emerged. MIPI cameras are currently the most widely-used embedded cameras as well as imaging interfaces on the market. They can quickly and effectively transmit electronic image information to the processor on the motherboard through dedicated FPC/FFC cables.

What is shown in FIG. 1 is a conventional FPC/FFC cable 10, including a cable body 12 and a cable connector 14. The cable connector 14 usually provides a single row of cable terminals 1401/1402 . . . 1422 configured to be connected to a motherboard PCB (not shown).

Although such wiring for signal transmission is convenient, it has many limitations in terms of function or efficacy. First is the length issue. The FPC/FFC cable 10 is usually limited to a length of less than 20 centimeters. If it is too long, it will face the problem of image function failure due to impedance matching. Secondly, FPC/FFC cables can usually be used inside the casing of the system host only, and cannot be used outside the casing of the system host.

Furthermore, the hardware connection between the FPC/FFC cable and the FPC/FFC connector is relatively weak. In addition, limited by the characteristics of the cable, it cannot withstand a high degree of bending, and the device itself does not have proper protections to interfere due to electromagnetic radiation in the surrounding. Once the cable is bent, it will affect the signal quality and even require replacement of new cables. Furthermore, the cable connector 14 has poor maintainability when fixed on a board terminal or at another connection port, and cannot withstand repeated plugging and unplugging or the movement of the cable position. Finally, camera devices on the market usually do not have uniform specifications, so the FPC/FFC cable must be redesigned according to the camera devices of different manufacturers. Therefore, there is no universal FPC/FFC connector, which reduces the pace of design and development, and increases production costs as well.

Accordingly, FPC connectors and FPC/FFC cables can only be designed to be used within the device casing, and cannot be used as an external cable. If a product requires a host platform with camera to be placed separately while the distance between the two exceeds 50 centimeters, it is not easy to implement an FPC solution.

Therefore, how to avoid the shortcomings of the above-mentioned drawbacks of the FPC/FFC devices is a technical problem that needs to be resolved.

### SUMMARY OF THE INVENTION

To overcome problems in the prior art, the present invention provides a module, a method and a structure for Transmitting Electronic Image signals of MIPI Camera. In order to use a cable to connect a MIPI camera and a motherboard equipped with a processor over a long distance, for example, to enable a mobile phone to be connected to a body-worn camera through an external cable so as to provide simultaneous video or photography functions to a user who is riding a bike outdoors, it is necessary to design the cable to have appropriate shielding and is suitable for carrying camera image signals. Generally speaking, camera image signals include at least one set of differential signals and one set of clock signals.

According to one aspect of the present invention, there is a module for transmitting an MIPI camera image signal, including an MIPI camera, a first connection device, a second connection device and a cable disposed between the first connection device and the second connection device. The MIPI camera is configured to generate the MIPI camera image signal. The first connection device includes a first USB Type-C connector and a first plurality of self-defined pins disposed within the first USB Type-C connector, and configured to be connected to a system host. The second connection device includes a second USB Type-C connector and a second plurality of self-defined pins disposed within the second USB Type-C connector, and configured to be connected to the MIPI camera. The cable includes at least 2 pairs of differential signal twisted wires configured to receive the MIPI camera image signal through the second plurality of self-defined pins.

The MIPI camera image signal includes at least one data signal and at least one clock signal, each of the first and second connection devices further includes in parallel a first row of contact terminals and a second row of contact terminals electrically connected to the first plurality of self-defined pins, and at least 2 pairs of pins in each of the first and second pluralities of self-defined pins are configured to transmit the at least one data signal and the at least one clock signal.

According to another aspect of the present invention, there is a method for transmitting an MIPI camera image signal. The method includes the following steps: providing a cable including at least one pair of differential signal twisted wires; providing a first connection device including a first USB Type-C connector; transmitting the MIPI camera image signal through the cable; and receiving the MIPI camera image signal transmitted by the cable via the first connection device. The MIPI camera image signal includes a clock signal, and the at least one pair of differential signal twisted wires is configured to transmit the clock signal.

According to one other aspect of the present invention, a structure for transmitting an MIPI camera image signal is disclosed. The structure includes a connection device and a pair of clock pins. The connection device includes a USB Type-C connector and a plurality of self-defined pins disposed within the first USB Type-C connector, wherein the MIPI camera image signal includes a clock signal. The pair of clock pins are among the plurality of self-defined pins, and configured to transmit the clock signal.

The cable device according to the present invention for transmitting electronic image signals is suitable for embedded systems such as industrial computers. It allows users to externally connect MIPI photography devices to an industrial computer, provides perfect shielding for electronic signals, and is suitable for repeated plugging and unplugging for many times. The specifications for manufacturing the cable device of the present invention can be according to the current electronic parts manufacturing methods in the art. Therefore, the present invention has industrial utility.

### BRIEF DESCRIPTION OF THE DRAWINGS

The objectives and advantages of the present invention will become more readily apparent to those ordinarily skilled in the art after reviewing the following detailed descriptions and accompanying drawings.

FIG. 1 is a schematic diagram showing a conventional FPC/FFC cable known to the art;

FIG. 2 is a schematic diagram showing a system for transmitting electronic image signals according to one embodiment of the present invention;

FIGS. 3 and 4 are schematic diagrams showing terminal positions of the connecting device of the cable device according to one embodiment of the present invention;

FIGS. 5A and 5B are schematic diagrams showing a structure for transmitting a MIPI camera image signal according to one embodiment of the present invention;

FIGS. 6A and 6B shows a schematic diagram showing a structure for transmitting a MIPI camera image signal according to one embodiment of the present invention;

FIG. 7 is a schematic diagram of a first embodiment of the circuit configuration of the cable device of the present invention;

FIG. 8 is a schematic diagram of a second embodiment of the circuit configuration of the cable device of the present invention;

FIG. 9 is a schematic diagram of a third embodiment of the circuit configuration of the cable device of the present invention;

FIG. 10 is a schematic diagram of a fourth embodiment of the circuit configuration of the cable device of the present invention;

FIG. 11 shows steps of a method for transmitting a MIPI camera image signal according to one embodiment of the present invention;

FIG. 12 is a schematic diagram showing a system for transmitting electronic image signals according to another embodiment of the present invention.

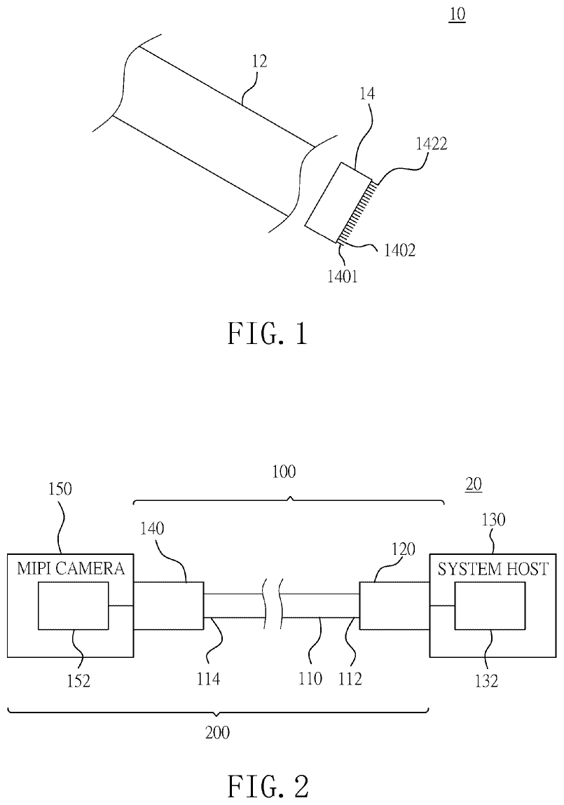

### a. DETAILED DESCRIPTION OF THE PREFERRED EMBODIMENTS

The present invention will now be described more specifically with reference to the following embodiments. It is to be noted that the following descriptions of the preferred embodiments of this invention are presented herein for purpose of illustration and description only; they are not intended to be exhaustive or to be limited to the precise form disclosed.

Please refer to FIG. 2, which illustrates a system 20 for transmitting electronic image signals according to one embodiment of the present invention. In FIG. 2, the system 20 includes a cable device 100. The cable device 100 includes a cable 110, and a first connection device 120 and a second connection device 140 respectively disposed on the first end 112 and the second end 114 of the cable 110. The first connection device 120 can be configured to be connected to a motherboard 132 of a system host 130. The second connection device 150 can be configured to be connected to an internal component 152 of a MIPI camera 150.

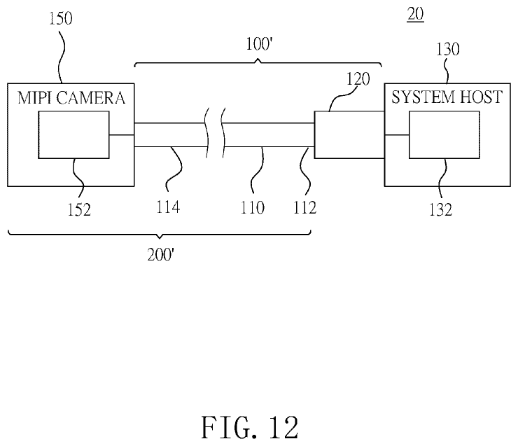

In one embodiment, the second end 114 can be directly connected to the internal component 152 (for example, directly connecting the signal lines of the cable 110 and a MIPI circuit board of the MIPI camera 150 point-to-point by soldering. In this case, there may be no need for the second connection device 140 to be configured or integrated into the MIPI camera 150 to achieve the goals of compact implementation, integrated design, and cost reduction.) For example, in FIG. 12, a schematic diagram of an embodiment of a cable device 110′ that does not require the configuration of a second connection device is shown.

In addition, the MIPI camera 150 and the cable device 100 can be integrated into a module 200 for transmitting MIPI camera image signals. Similarly, in FIG. 12, the MIPI camera 150 and the cable device 100′ can be integrated into a module 200.

The cable 110 is composed of a plurality of wires (not shown in the figure) used to transmit camera image signals or power at the center, and is surrounded with a shielding device (not shown in the figure) containing a metal conductor material on the periphery. The cable 110 may include at least one pair of differential signal stranded wires (not shown in the figure). In order to effectively carry the camera image signals, taking the MIPI camera image signal as an example, the impedance value of the differential signal stranded wires specified by the MIPI interface in this embodiment is about 100 ohms, and the maximum acceptable specification is 90-110 ohms, which is better in 92-108 ohms, and preferably 95-105 ohms.

In the point-to-point cable 110, both ends 112,114 of each wire can be directly as well as electrically connected to the terminals (not shown in the figure) of the first and the second connection devices 120,140 respectively in a point-to-point manner. The total number of wires and terminals are the same. The connections are configured in a one-to-one manner according to a specific design. According to some embodiments of the present invention, the terminals in the first connection device 120 and the second connection device 140 are configured in exactly the same manner, and the other components such as the housing of the connecting device are also the same. Since the terminals in the connection devices 120,140 are arranged in the same manner, this arrangement can ensure that the signals carried by each terminal in the first connection device 120 can be reliably transmitted to the corresponding terminals in the second connection device 140. The signals, in other words, each form a one-to-one conduction state in parallel.

According to an embodiment of the present invention, the length of the cable device 100 for transmitting electronic image signals is greater than 20 centimeters (cm). According to other embodiments of the present invention, the length of the cable device 100 is greater than 50 cm. The actual length may be about 70-90 cm, 100-120 cm, 130-150 cm, or even 150-200 cm, depending on the application conditions. It is up to the designer to modify the length when necessary.

Because the structure of the cable according to the embodiment of the present disclosure is to gather a plurality of individual conducting wires into a bundle, it can be bent and turned appropriately without damaging the functions of each conducting wire. Pairs of stranded wires are bent and wound close to each other in the cable, there are no other lines intervening between each pair of twisted wires, so the differential signals carried therein are not interfered by other wire signals. The cable device 100 has a shielding device, such as a meshed metal wire or a metal sheet, which can block electromagnetic radiation or electromagnetic field interference from the outside, so that the electronic signals carried by the wires in the cable are protected from external interference. Since electronic image signals are susceptible to interference, in the embodiment of the present disclosure, the cable device 100 is particularly suitable for use in MIPI interfaces through the above configuration, especially for transmitting electronic image signals, so that the signals are free from interference and can be transmitted under appropriate impedance matching conditions.

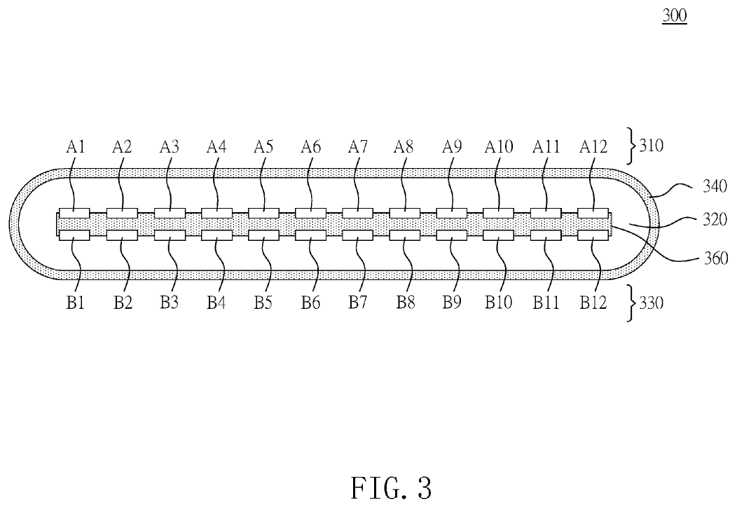

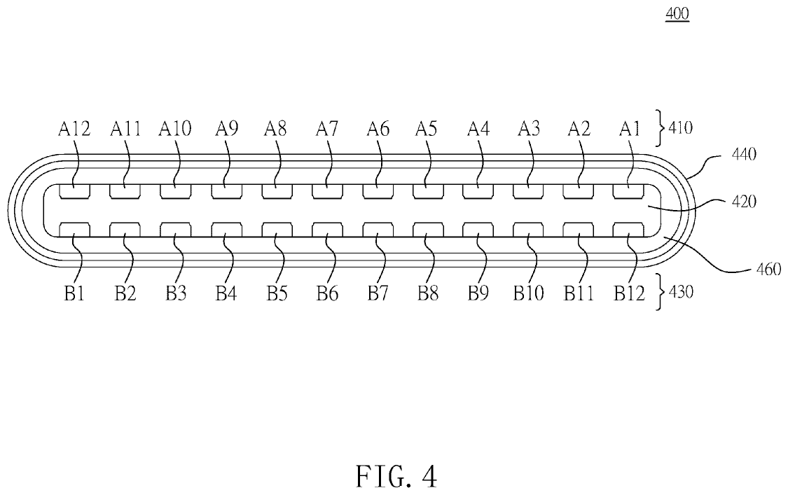

FIGS. 3 and 4 are schematic views of the terminal positions of the connection device 120/140 of the cable device of the present disclosure when viewed from the outside. FIG. 3 is a schematic view of the terminal positions of a socket (female) end embodiment, and FIG. 4 can be a schematic diagram of the terminal locations of a plug (male) end embodiment. It should be noted that the total numbers of terminals shown in FIGS. 3 and 4 are only for reference. The number of terminals in the present invention is not limited to the illustrations in the figures. The designer can modify the numbers according to practical needs. In a preferred embodiment, the number of the terminals may be at least 20, preferably 24, and may be configured with an equal number of upper and lower rows of terminals at corresponding positions.

At the opening position of the connection device 300 as shown in FIG. 3, there are an upper row 310 of contact terminals and a lower row 330 of contact terminals, with a spacing area 320 between the two rows 310, 330. The terminal positions of the upper row 310 of contact terminals, from left to right, are denoted by A1, A2, A3 . . . , A12, and the terminal positions of the lower row 330 of contact terminals, from left to right, are denoted by B12, B11, B10 . . . , B1, respectively. It can be understood from the illustrations that the positions the terminals having a total number of 12 in each of the upper and lower lows 310, 320 are opposite and juxtaposed to each other. In addition, the connection device 300 also includes a housing 340, which can be made of metal and serves as a shield.

Likewise, at the opening position of the connection device 400 shown in FIG. 4, there are an upper row 410 of contact terminals and a lower row 430 of contact terminals, with a spacing area 420 between the two rows 410, 420. The terminal positions of the upper row 410 contact terminals, from left to right, are denoted by A12, A11, A10 . . . , A1, and the terminal positions of the lower row 430, from left to right, are denoted by B1, B2, B3 . . . , B12, respectively. It can be understood from the illustrations that the positions of the terminals having a total number of 12 in each of the upper and lower lows 410, 420 are opposite and juxtaposed to each other. In addition, the connection device 400 also includes a housing 440, which can be made of metal and serves as a shield. The skilled person in this field can understand that the cable connection device can be configured as a socket (female) end or a plug (male) end, depending on practical requirements. That is, the connection devices at both ends can be configured as two male, two female, or one male and one female, and none of these goes beyond the scope of the present invention.

What FIGS. 3 and 4 illustrate are merely the terminal positions. The actual device can be implemented with gold-plated electrical connection pads commonly known as gold fingers or metal contact terminals, but is not limited to these embodiments. Basically, the first and the second connection devices 120, 140 on the cable device 100 for transmitting camera image signals of the present invention are suitable for multiple times of plugging and unplugging. According to some embodiments, the first connection device 120 is designed to be configured to be connected to an edge position of a motherboard of a host system. Usually, the edge position of the board is configured with a corresponding connection device, so that the two can fit to each other. The camera image signal can be transmitted to the host system through the cable device 100. Since the first connection device 120 is designed to be connected to the board edge, board end or coastline, it will not occupy the space on the PCB, so that the device can provide a better space utilization, and the force exerted during the plugging and unplugging process will not cause extra burden of stress on the front end of the PCB.

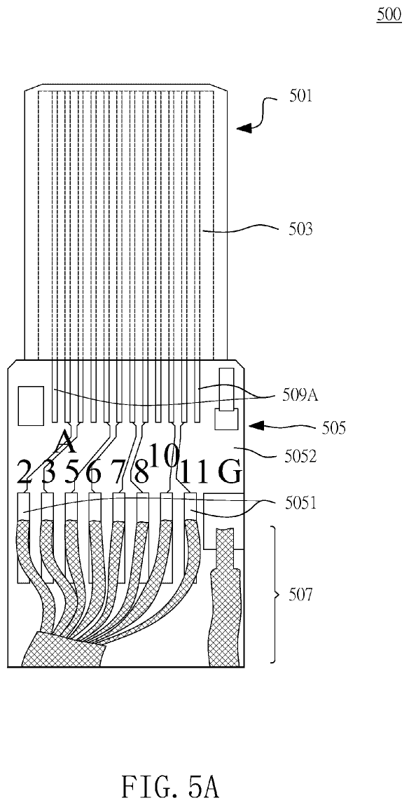

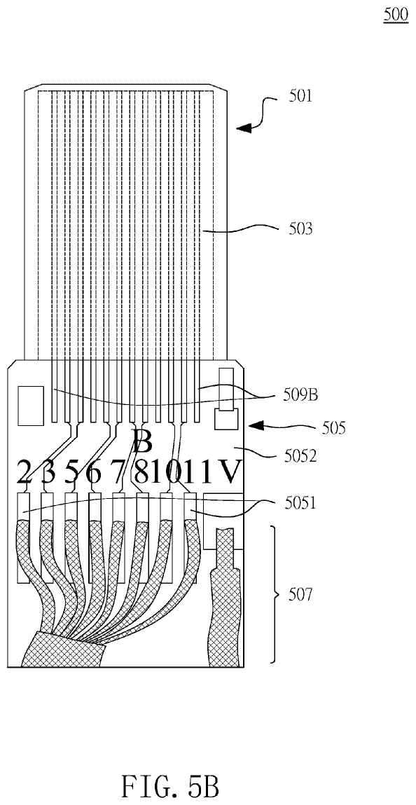

Please refer to FIGS. 5A and 5B, which illustrate an embodiment of a structure 500 for transmitting a MIPI camera image signal according to the present disclosure. Note that although this embodiment uses a plug end as an example, it can also be applied to a socket end. The structure 500 may include a connection device 501 that includes a USB Type-C connector 503 and a bearing board 505 with a plurality of self-defined pin positions 5051 disposed in the housing of the USB Type-C connector 503. The carrier board may include a printed circuit board (PCB), a plastic insulating tongue (see FIG. 3, 360), a plastic insulating substrate (see FIG. 4, 460), or a combination thereof. The USB Type-C connector may include portions other than the pins of the traditional USB Type-C connector (for example, metal casing, terminals, carrier plates and etc.).

The plurality of self-defined pins 5051 may, for example, make use of a traditional USB Type-C connector, but internally use terminals or pin configurations being different from the traditional USB Type-C connector, such as replacing the data pins with clock pins, or replacing the pins originally configured to the confirmation of transmission direction or reverse insertion with that for transmitting special data or clock. Therefore, the plurality of self defined pins 5051 can be configured to be connected in series with another connection device (eg., a socket end) in a fixed direction (that is, non-reversible). In one embodiment, the USB Type-C connector 503 does not require the use of a printed circuit board (PCB).

The structure 500 may further include a cable 507 having at least one pair of differential signal twisted wires electrically connected to the plurality of self-defined pins 5051. Wherein, the plurality of self-defined pins 5051 may include at least 20 pins; the MIPI camera image signal includes a clock signal; and a pair of clock pins (for example, a clock signal line CLK which may include CLKP and CLKN) in the plurality of self-defined pins 5051 is configured to transmit the clock signal.

In one embodiment, the MIPI camera image signal may further include a total number of N data signals, and the N is greater than or equal to 1. The plurality of self-defined pins 5051 may further include a total number of M pairs of data pins (for example, a high-speed data transmission line TX, which may include TXP and TXN; or data transmission line D, which may include DP and DN) are configured to correspondingly transmit the number of N data signals, wherein the M is greater than or equal to the N. The cable 507 includes one pair of differential signal twisted wires and M pairs of differential signal twisted wires that are electrically connected to the pair of clock pins and the M pairs of data pins respectively. In a preferred embodiment, the M pairs of data pins are all configured as high-speed data transmission lines, and the M ranges from 1 to 5.

In a preferred embodiment, the M is equal to 5, so that the same cable device can be used to meet the usage requirements of almost all MIPI cameras. That is to say, when M is 5, the cable device can be equipped with the same connector and the self-defined pin positions, and can be used in various scenarios. Designers and developers may only need to connect cables in series according to different types of MIPI cameras. This significantly increases the speed of design and development, standardizes mass manufacturing of products, and reduces production costs.

In one embodiment, the cable 507 is directly connected to an internal component of a MIPI camera (for example, a signal line of the cable 507 is directly connected point-to-point by soldering to a MIPI circuit board of the MIPI camera, thereby achieving the purposes of simplification of process implementation, integrated design, and cost reduction).

In any embodiment, the plurality of self-defined pins 5051 can be configured to be connected in series with another connection device (for example, a socket end) in a fixed direction (that is, not reversible), and can be implemented mechanically or with other fool-proof methods.

In one embodiment, the plurality of self-defined pins 5051 may further include a total number of L general-purpose input/output (GPIO) pins, and the L is equal to 1 or 2. Through the GPIO pins, the system host can increase the function control of the MIPI camera so as to increase the efficacy.

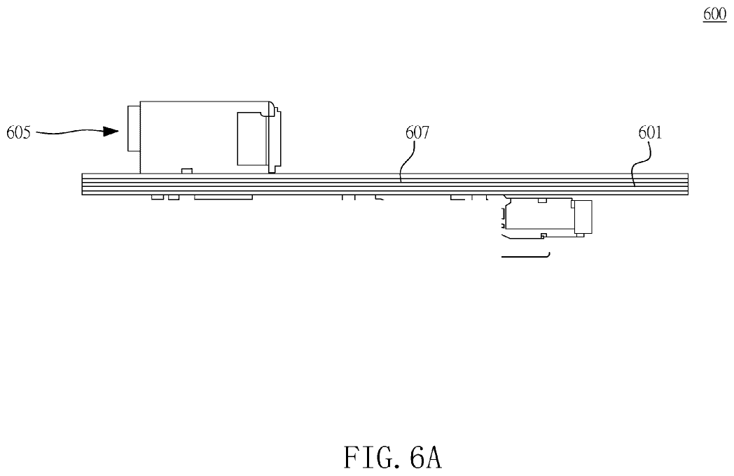

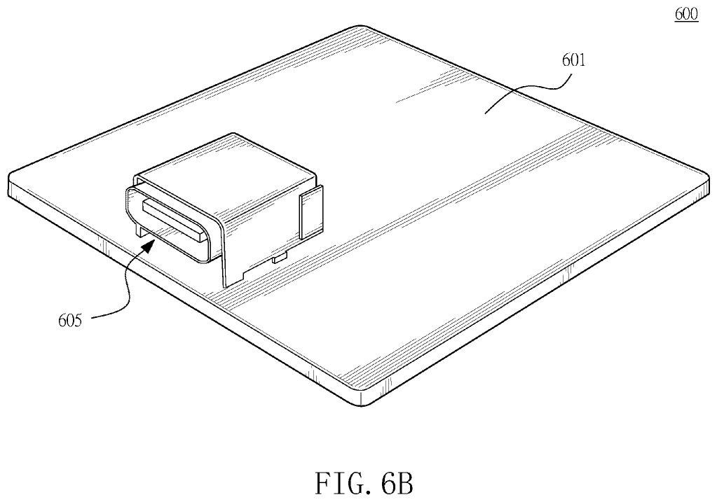

In addition, referring to FIGS. 6A and 6B, a structure 600 for transmitting a MIPI camera image signal is disclosed. The structure 600 may include an adapter board 601 having an FPC/FFC connection portion 603, a USB Type-C connection portion 605 and an adapter circuit 607 connected to the FPC/FFC connection portion 603 and the USB Type-C connection portion. Between 605. The FPC/FFC connection portion 603 is configured to receive or transmit the MIPI camera image signals through an FPC/FFC connector. The USB Type-C connection portion 605 is configured to receive or transmit the MIPI camera image signals through the adapter circuit 607.

In one embodiment, the bearing board 505, 605 is configured to connect a MIPI camera. The cable 507 may include at least two pairs of differential signal twisted wires, and receives the MIPI camera image signals through the carrier board 505, wherein the MIPI camera image signal includes at least one data signal and at least one clock signal. The connection device 501 further includes a first row of contact terminals 509A and a second row of contact terminals 509B that are parallel and electrically connected to the plurality of self-defined pins 5051, and at least 2 pairs of pins in the plurality of self-defined pins 5051 are configured to transmit the at least one data signal and the at least one clock signal. In addition, each of the at least two pairs of differential signal twisted wires can be connected to one pair of adjacent terminals corresponding to the first row of contact terminals 509A and the second row of contact terminals 509A through the plurality of self-defined pins 5051.

In one embodiment, the first row of contact terminals 509A and the second row of contact terminals 509B have the same number and are juxtaposed oppositely, and can be electrically connected to the plurality of self-defined pins 551 in a point-to-point manner (that is, directly connected without passing through other electronic components. However, the point-to-point connection is not necessarily a one-to-one manner, and may be a plural-to-one manner, such as a shared power line or a shared grounding). In addition, the bearing board 505 includes a printed circuit board (PCB) 5052, and the PCB 5052 may not have a built-in control chip (for example, E-Mark IC). With this special design, the MIPI camera image signal transmission device can further improve its transmission efficiency, being more extendable, and reduce production cost.

In a preferred embodiment, the middle section of the connecting lines between each pair of adjacent terminals in the first row of contact terminals 509A and the second row of contact terminals 509B that transmit or receive differential signals and the corresponding pair of pins in the plurality of self-defined pins 5051 are close to each other and basically parallel to each other.

In one embodiment, the MIPI camera image signals include a clock signal and a total number of N data signals, and the N is greater than or equal to 1. The plurality of self-defined pins 5051 include a pair of clock pins (for example, clock signal line CLK, which may include CLKP and CLKN) are configured to transmit the clock signal. A total number of M pairs of data pins (for example, the high-speed data transmission line TX, which may include TXP and TXN, or the data transmission line D, which may include DP and DN) are configured to transmit the N data signals correspondingly, wherein the M is greater than or equal to the N. The cable 507 may include 1 pair of differential signal twisted wires and the M pairs of differential signal twisted wires, electrically connected to the pair of clock pins and the M pairs of data pins respectively. In a preferred embodiment, the M pairs of data pins are all configured as high-speed data transmission lines, and the M ranges from 1 to 5.

In a preferred embodiment, the M equals to 5, so that the same cable device can be used to meet the usage requirements of almost all MIPI cameras. That is to say, when M is 5, the cable device can use the same connector and the self-defined pin positions, and can be used in various scenarios. Designers and developers only need to connect cables in series according to different types of MIPI cameras. This significantly increases the speed of design and development, standardizes the mass production, and significantly reduces production costs.

In one embodiment, the plurality of self-defined pins 5051 further includes at least one pair of redundant pins, and the cable 507 further includes at least another pair of differential signal twisted wires electrically connected to the at least one pair of redundant pins. The redundant pins can be used as a replacement spare for maintenance. When other differential signal circuits in use fail, the additional pair of differential signal twisted wires can be used as a replacement line. Alternatively, when designers need to apply more pairs of differential signal circuits, the redundant pins and wires can also be used directly.

In one embodiment, a cable device 100 for transmitting a MIPI camera image signal may include a structure 500, and the structure 500 may serve as a first connection device 120. Referring also to FIG. 2, the cable device 100 further includes a second connection device 140. The second connection device 140 may have the same or corresponding component configuration as the first connection device 120 (for example, two male terminals, one male and one female terminals, or two female terminals), and the first connection device 120 is configured to be connected to an edge of a motherboard 132. Thereby, the MIPI camera image signal can be transmitted to the motherboard 132 through the cable device 100. In one embodiment, the MIPI camera 150 and the cable device 100 can be integrated into a module 200 for transmitting MIPI camera image signals.

In addition, in one embodiment, the shell of the USB Type-C connector 503 can be made of metal to serve as a shield. The first row of contact terminals 509A and the second row of contact terminals 509B also include terminals being configured to transmit electric power (Power), serial clock (SCL), serial data (SDA), reset (RST), master clock (MCLK) or General purpose input/output (GPIO) and other signals. In a preferred embodiment, the power signal terminal is configured to deliver a voltage of 3-4 volts and a current of at least 1 amp. The plurality of self-defined pins 5051 further includes a total number of L GPIO pins, and the L is equal to 1 or 2. Through the GPIO pins, the system host can increase the function control of the MIPI camera to increase the efficiency of usage.

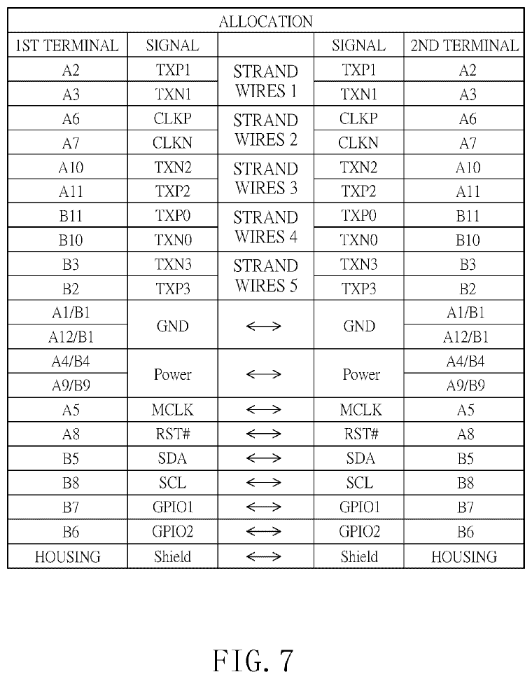

Please refer to FIG. 7, which shows the first embodiment of the circuit configuration of the cable device of the present invention. As shown in the figure, the housings at both ends of the cable device also have shielding functions, and the contact terminals at opposite positions at the two ends are configured to carry or transmit the same signal. In the embodiments shown in FIGS. 7 to 10, the contact terminals located at the most side positions A1/B1/A12/B12 are all for ground circuits, and the power line is configured to located at the contact terminals A4/B4/A9/B9. Such configurations will not be repeated below.

In addition, referring to FIG. 5A and FIG. 5B simultaneously, in one embodiment, the contact terminals A1/B1/A12/B12 are connected to a common ground line G in a point-to-point manner, and the contact terminals A4/B4/A9/B9 are connected in a point-to-point manner to a common power line V. The remaining contact terminals can be connected to the corresponding pins in a one-to-one as well as point-to-point manner.

Also referring to the opening portion of the connecting device 300 or 400 shown in FIGS. 3 and 4, in the embodiment shown in FIG. 7, the two contact terminals A2 and A3 at adjacent positions in the upper column 310 or 410 are configured to carry a pair of differential signals TXP1 and TXN1 respectively, and the contact terminals at corresponding positions on the first and the second terminals are electrically connected to each other through the first pair of twisted wires in the point-to-point cable 110. The two contact terminals A6 and A7 at the adjacent position in the above column 310 or 410 carry a pair of differential signals CLKP and CLKN respectively, and the contact terminals at corresponding positions on the first and the second terminals are electrically connected to each other through the second pair of twisted wires in the point-to-point cable 110. The two contact terminals A10 and A11 at adjacent positions in the upper row 310 or 410 carry a pair of differential signals TXN2 and TXP2 respectively, and the contact terminals at corresponding positions on the first and second terminals are electrically connected to each other through the third pairs of twisted wires in the point-to-point cable 110. The differential signals CLKP and CLKN denote clock signals, while the differential signals TXP1, TXN1, TXN2 and TXP2 can be used to transmit data signals.

In the embodiment shown in FIG. 7, the two contact terminals B11 and B10 at adjacent positions in the lower row 330 or 430 carry a pair of differential signals TXP0 and TXN0 respectively, and the contact terminals at the relative positions on the first and the second terminals are electrically connected to each other through the fourth pair of twisted wires in the point-to-point cable 110. The two contact terminals B3 and 62 at adjacent positions in the lower row 330 or 430 carry a pair of differential signals TXN3 and TXP3 respectively, and the contact terminals at corresponding positions on the first and the second terminals are electrically connected to each other through the fifth pair of twisted wires in the point-to-point cable 110. The differential signals TXP0 and TXN0, TXN3 and TXP3 can be configured to transmit data signals.

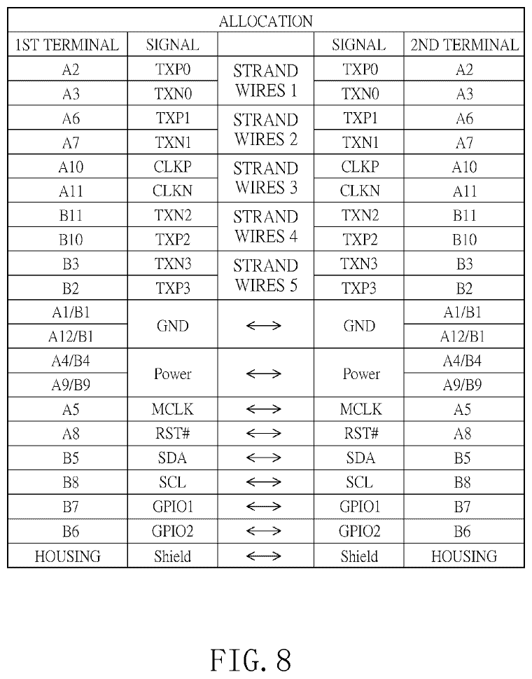

Please refer to FIG. 8, which shows the second embodiment of the circuit configuration of the cable device of the present invention. Also referring to the opening portion of the connecting device 300 or 400 as shown in FIGS. 3 and 4, in the embodiment shown in FIG. 8, the two contact terminals A2 and A3 at adjacent positions in the row 310 or 410 are configured to carry a pair of differential signals TXP0 and TXN0 respectively, and the contact terminals at the corresponding positions on the first and the second terminals are electrically connected to each other through the first pair of twisted wires in the point-to-point cable 110. The contact terminals at the two adjacent positions A6 and A7 in the upper row 310 or 410 are configured to carry a pair of differential signals TXP1 and TXN1 respectively, and the contact terminals at corresponding positions on the first and the second terminals are electrically connected to each other through the second pair of twisted wires in the point-to-point cable 110. The two contact terminals A10 and A11 at adjacent positions in the upper row 310 or 410 are configured to carry a pair of differential signals CLKP and CLKN respectively, and the contact terminals at corresponding positions on the first and second terminals are electrically connected to each other through the third pair of twisted wires in the point-to-point cable 110. The differential signals CLKP and CLKN denote the clock signal.

In the embodiment shown in FIG. 8, the two contact terminals B11 and B10 at adjacent positions in the lower rows 330 or 430 are configured to carry a pair of differential signals TXN2 and TXP2 respectively, and the contact terminals at the corresponding positions on the first and the second terminals are electrically connected to each other through the fourth pair of twisted wires in the point-to-point cable 110. The two contact terminals B3 and B2 at adjacent positions in the lower row 330 or 430 are configured to carry a pair of differential signals TXN3 and TXP3 respectively, and the contact terminals at corresponding positions on the first and the second terminals are electrically connected to each other through the fifth pair of twisted wires in the point-to-point cable 110. The differential signals TXP0, TXN0, TXP1, TXN1, TXN2, TXP2, TXN3 and TXP3 can be configured to transmit data signals.

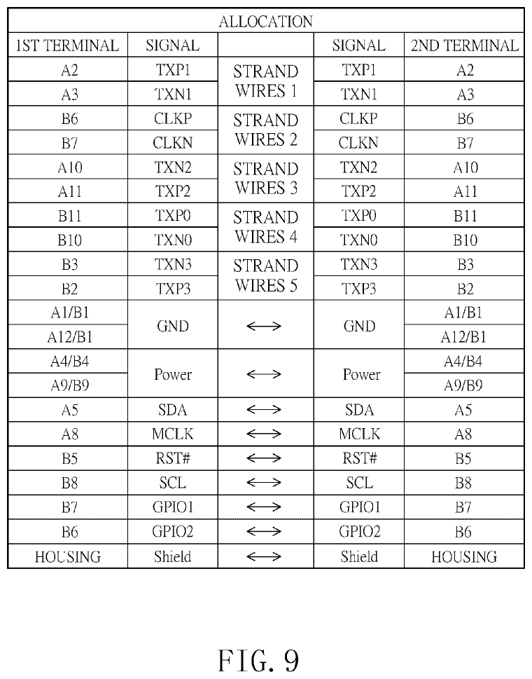

Please refer to FIG. 9, which shows the third embodiment of the circuit configuration of the cable device of the present invention. Also referring to the opening portion of the connecting device 300 or 400 shown in FIGS. 3 and 4, in the embodiment shown in FIG. 9, the two contact terminals A2 and A3 at adjacent positions in the row 310 or 410 are configured to carry a pair of differential Signals TXP1 and TXN1 respectively, and the contact terminals at corresponding positions on the first and the second terminals are electrically connected to each other through the first pair of twisted wires in the point-to-point cable 110. The two contact terminals at adjacent positions B6 and B7 in the lower row 330 or 430 are configured to carry a pair of differential signals CLKP and CLKN respectively, and the contact terminals at corresponding positions on the first and the second terminals are electrically connected to each other through the second pair of twisted wires in the point-to-point cable 110. The two contact terminals A10 and A11 at adjacent positions in the upper row 310 or 410 are configured to carry a pair of differential signals TXN2 and TXP2 respectively, and the contact terminals at corresponding positions on the first and the second terminals are electrically connected to each other through the third pair of twisted wires in the point-to-point cable 110. The differential signals CLKP and CLKN denote the clock signal.

In the embodiment shown in FIG. 9, the two contact terminals B11 and B10 at adjacent positions in the lower row 330 or 430 are configured to carry a pair of differential signals TXP0 and TXN0 respectively, and the contact terminals at the relative positions on the first and the second terminals are electrically connected to each other through the fourth pair of twisted wires in the point-to-point cable 110. The two contact terminals B3 and B2 at adjacent positions in the lower row 330 or 430 are configured to carry a pair of differential signals TXN3 and TXP3 respectively, and the contact terminals at corresponding positions on the first and the second terminals are electrically connected to each other through the fifth pair of twisted wires in the point-to-point cable 110. The differential signals TXP0, TXN0, TXP1, TXN1, TXN2, TXP2, TXN3 and TXP3 can be configured to transmit data signals.

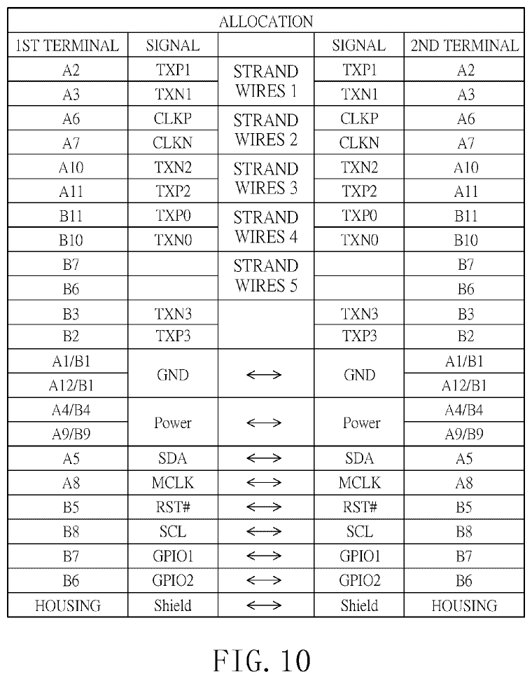

Please refer to FIG. 10, which shows the fourth embodiment of the circuit configuration of the cable device of the present invention. Also referring to the opening portion 300 or 400 of the connecting device shown in FIGS. 3 and 4, in the embodiment shown in FIG. 10, the two contact terminals A2 and A3 at adjacent positions in the upper row 310 or 410 are configured to carry a pair of differential signals TXP1 and TXN1 respectively, and the contact terminals at corresponding positions on the first and second terminals are electrically connected to each other through the first pair of twisted wires in the point-to-point cable 110. The two contact terminals at the adjacent positions A6 and A7 in the upper row 310 or 410 are configured to carry a pair of differential signals CLKP and CLKN respectively, and the contact terminals at corresponding positions on the first and the second terminals are electrically connected to each other through the second pair of twisted wires in the point-to-point cable 110. The two contact terminals A10 and A11 at adjacent positions on the upper row 310 or 410 are configured to carry a pair of differential signals TXN2 and TXP2 respectively, and the contact terminals at corresponding positions on the first and the second terminals are electrically connected to each other through the third pair of twisted wires in the point-to-point cable 110. The differential signals CLKP and CLKN denote the clock signal.

In the embodiment shown in FIG. 10, the two contact terminals B11 and B10 at adjacent positions in the lower row 330 or 430 are configured to carry a pair of differential signals TXP0 and TXN0 respectively, and the contact terminals at the corresponding positions on the first and the second terminals are electrically connected to each other through the fourth pair of twisted wires in the point-to-point cable 110. The two contact terminals B6 and B7 at adjacent positions in the lower row 330 or 430 provide two reserved backup contact terminals, and the contact terminals at the corresponding positions on the first and the second terminals are electrically connected to each other through the fifth pair of twisted wires in the point-to-point cable 110. The two contact terminals B3 and B2 at adjacent positions in the lower row 330 or 430 are configured carry a pair of differential signals TXN3 and TXP3 respectively, the contact terminals at corresponding positions on the first and the second terminals are electrically connected to each other through the sixth pair of twisted wires in the point-to-point cable 110.

In the embodiment shown in FIG. 10, a pair of backup wires provided by the sixth pair of twisted wires in the point-to-point cable 110 can be used as a replacement spare for maintenance, which can be used as a replacement part when other differential signal wires in use fail. Alternatively, they can also be used directly when the designer needs to apply a sixth pair of differential signal wires.

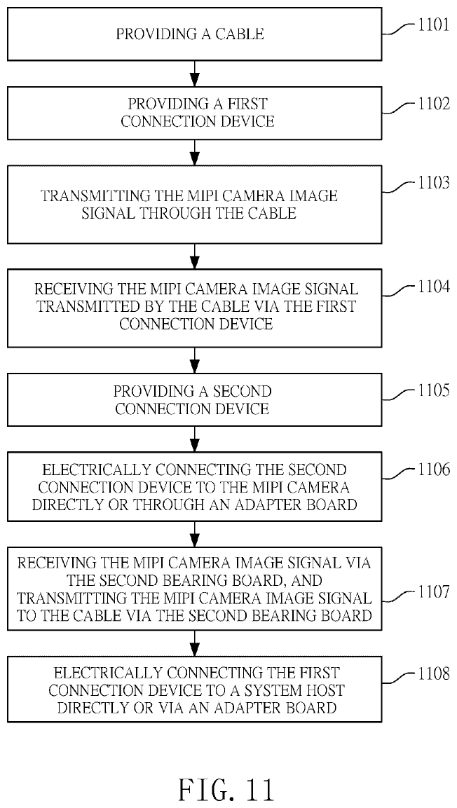

As shown in FIG. 11, an embodiment of a method for transmitting a MIPI camera image signal is disclosed. The method includes steps of providing a cable that includes at least one pair of differential signal twisted wires (S1101); providing a first connection device that includes a first USB Type-C connector (S1102); through the cable, transmitting the MIPI camera image signal (S1103); and receiving the MIPI camera image signal transmitted by the cable through the first connection device (S1104), wherein the MIPI camera image signal includes a clock signal, and the at least one pair of differential signal twisted wires are configured to carry the clock signal.

In one embodiment, the method for transmitting a MIPI camera image signal further includes the following steps of: providing a second connection device (S1105), the second connection device including a second USB Type-C connector and second bearing board having a second plurality of self-defined pin positions and disposed in the second USB Type-C connector; electrically connecting the second connection device to the MIPI camera directly or through an adapter board (S1106); receiving the MIPI camera image signal and transmits the MIPI camera image signal to the cable through the second bearing board (S1107); and electrically connecting the first connection device to a system host directly or through an adapter board (S1108).

Wherein, the MIPI camera image signal includes a clock signal and a total number of N data signals, and the N is greater than or equal to 1, the first connection device further includes a first bearing board having a first plurality of self-defined pins and disposed inside the first USB Type-C connector. The first plurality of self-defined pins includes a pair of clock pins configured to receive the clock signal and a total number of M pairs of data pins configured to receive the N data signals correspondingly, wherein the M is greater than or equal to the N. The second plurality of self-defined pins includes a pair of clock pins configured to transmit the clock signal and a total number of the M pairs of data pins configured to correspondingly transmit the number of N data signals, the cable includes a pair of differential signal twisted wires electrically connected between the pair of clock pins of the first and second plurality of self-defined pins, and the M pairs of differential signal twisted wires are electrically connected between the M pairs of data pins of the first and the second plurality of self-defined pins.

In one embodiment, designers can define the first plurality of self-defined pins and the second plurality of self-defined pins according to the specifications of a MIPI camera, where the M can range from 1 to 5. In one embodiment, a current with voltage of 3 to 4 volts and at least 1 amp can be transmitted through the power signal wires in the cable, and the device can be configured to send a control signal from the system host to the MIPI camera through two general-purpose input/output pins among the plurality of self-defined pins. Through the GPIO pins, the host side of the system can increase the function control of the MIPI camera to increase the efficiency of use. Designers can change the length of the cable according to needs, so that the connection distance between the MIP camera and the system host can be satisfied from a usage scenario of 20 centimeters to a usage scenario of more than 2 meters.

Based on the above embodiments, it can be understood that in the cable device 100 for transmitting camera image signals proposed by the present invention, any pair of differential signal twisted wires can be respectively connected to a pair of adjacent terminals in the same row of contact terminals, so the differential signal circuits carried and transmitted by the device can be configured close by to avoid interference from other electronic signals in the cable device 100. Since the device is used to transmit camera image signals, at least one pair of the at least five pairs of differential signal twisted wires is a clock signal. Moreover, since the number of contact terminals of the cable is sufficient, the present invention can provide different positions to carry differential signals as needed, or provide a larger number of differential signal strands to cope with different application modes.

In a preferred embodiment, there are printed circuit boards in the point-to-point cable device (for example, each of the first connecting device 120 and the second connecting device 140 has a set of printed circuit boards), and these printed circuit boards have no built-in control chip. Therefore, in the cable device of the present invention, the connection devices 120, 140 at both ends have simple structure and good tolerance and impact resistance, which increases the efficiency of use. Besides, in addition to the necessary power supply (Power) and ground (GND) terminals, the other terminals can be defined as long as they meet the requirements of 5 sets of differential signal pairs, which can provide great flexibility in terms of design and application.

In a preferred embodiment, the other terminals can be used for the serial clock (SCL) and serial data (SDA) signals of Inter-Integrated Circuit (I2C), reset (RST) signal, low power (PWDN) signal, master clock (MCLK) signal or general purpose input/output (GPIO) signal. In a preferred embodiment, the GPIO terminal occupies two sets of terminals.

In a preferred embodiment, the wire core of the point-to-point cable in the present invention can mostly be tin-plated copper wires or ultra-fine coaxial wires. If low signal loss is required, silver-plated copper wires can be used. If there is a need to transmit a large current, one may choose an oxygen-free copper core for customization. There will be a layer of PE polyethylene material between the wire and the outer sheath, mainly for insulation. The outer sheath or outer quilt of the wires can be made of at least one of polyvinyl chloride (PVC) and polyurethane (PU).

The embodiments of the point-to-point cable device in this case can have good impedance matching and can effectively increase the transmission length thereof. Compared with traditional FPC/FFC cables, they have better shielding effect, reduced external interference, and can solve the problem of image signal failure caused by the bending of traditional FPC/FFC cables.

While the invention has been described in terms of what is presently considered to be the most practical and preferred Embodiments, it is to be understood that the invention need not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A module for transmitting an MIPI camera image signal, comprising:
an MIPI camera configured to generate the MIPI camera image signal;
a first connection device including:
a first USB Type-C connector; and
a first plurality of self-defined pins disposed within the first USB Type-C connector, and configured to be connected to a system host;
a second connection device including:
a second USB Type-C connector; and
a second plurality of self-defined pins disposed within the second USB Type-C connector, and configured to be connected to the MIPI camera; and
a cable disposed between the first connection device and the second connection device, and including at least 2 pairs of differential signal twisted wires configured to receive the MIPI camera image signal through the second plurality of self-defined pins, wherein:
the MIPI camera image signal includes at least one data signal and at least one clock signal,
each of the first and second connection devices further includes in parallel a first row of contact terminals and a second row of contact terminals electrically connected to the first plurality of self-defined pins, and
at least 2 pairs of pins in each of the first and second pluralities of self-defined pins are configured to transmit the at least one data signal and the at least one clock signal.

2. The module as claimed in claim 1, wherein an amount of the first row of contact terminals is the same as that of the second row of contact terminals, and the first and the second rows of contact terminals in either of the first and the second connection devices are electrically connected to the corresponding pins in a respective one of the first and second pluralities of self-defined pins in a point-to-point manner.

3. The module as claimed in claim 1, wherein the first connection device further includes a first bearing board, and the first plurality of self-defined pins are disposed on the first bearing board.

4. The module as claimed in claim 3, wherein the second connection device further includes a second bearing board, and the second plurality of self-defined pins are disposed on the second bearing board.

5. The module as claimed in claim 4, wherein either of the first and the second bearing boards includes a printed circuit board without an internal control chip thereon.

6. The module as claimed in claim 1, wherein the cable has a wire core and an outer cover, and the wire core is selected from at least one of a tinned copper wire, an ultra-fine coaxial wire and an oxygen-free copper core.

7. The module as claimed in claim 6, wherein a layer of a polyethylene (PE) material is disposed between the wire and the outer cover, and the outer cover is formed of at least one of a polyvinyl chloride (PVC) and a polyurethane (PU).

8. The module as claimed in claim 1, wherein:
the first row of contact terminals and the second row of contact terminals are juxtaposed;
the MIPI camera image signal includes a clock signal and a total number of N data signals, and the N is greater than or equal to 1; and
either of the first and second pluralities of self-defined pins includes a pair of clock pins configured to transmit the clock signal, and a total number of M pairs of data pins configured to correspondingly transmit the N data signals, and the M is greater than or equal to N.

9. The module as claimed in claim 8, wherein the cable includes a pair of differential signal stranded wires and a total number of M pairs of differential signal stranded wires electrically connected to the pair of clock pins and the M pairs of data pins respectively in either of the first and second pluralities of self-defined pins, and the M data pins are configured as high-speed data transmission lines.

10. The module as claimed in claim 9, wherein:
the module further comprises a motherboard;
the first connecting device is configured to be connected to an edge position of the motherboard;
the USB Type-C connector has a shell as a shielding element;
the first and the second row of contact terminals further include terminals configured to transmit signals including power, serial clock, serial data, reset, main clock or general input/output;
the M ranges from 1 to 5;
either of the first and the second pluralities of self-defined pins further includes at least one pair of alternative pins, and the cable further includes at least one other pair of differential signal twisted wires electrically connected to the at least one pair of alternative pins respectively in either of the first and the second pluralities of self-defined pins; and
either of the first and the second pluralities of self-defined pins further includes a total number of L general-purpose input/output pins, and the L is equal to 1 or 2.

11. A method for transmitting an MIPI camera image signal, comprising steps of:
providing a cable including at least one pair of differential signal twisted wires;
providing a first connection device including a first USB Type-C connector;
transmitting the MIPI camera image signal through the cable; and
receiving the MIPI camera image signal transmitted by the cable via the first connection device, wherein:
the MIPI camera image signal includes a clock signal; and
the at least one pair of differential signal twisted wires is configured to transmit the clock signal.

12. The method as claimed in claim 11, further comprising steps of:
providing a second connection device including a second USB Type-C connector having a second bearing board disposing thereon a second plurality of self-defined pins;
electrically connecting the second connection device to the MIPI camera directly or through an adapter board;
receiving the MIPI camera image signal via the second bearing board, and transmitting the MIPI camera image signal to the cable via the second bearing board; and
electrically connecting the first connection device to a system host directly or via an adapter board.

13. The method as claimed in claim 12, wherein:
the MIPI camera image signal includes a clock signal; and
the at least one pair of differential signal twisted wires is configured to transmit the clock signal.

14. A structure for transmitting an MIPI camera image signal, comprising:
a connection device including a USB Type-C connector and a plurality of self-defined pins disposed within the first USB Type-C connector, wherein:
the MIPI camera image signal includes a clock signal; and
a pair of clock pins among the plurality of self-defined pins are configured to transmit the clock signal.

15. The structure as claimed in claim 14, further comprising a cable, wherein:
the MIPI camera image signal includes a total number of N data signals, and the N is greater than or equal to 1;
the plurality of self-defined pins include a total number of M pairs of data pins configured to correspondingly transmit the N data signals, where the M is greater than or equal to N; and
the cable includes a pair of differential signal twisted wires and M pairs of differential signal twisted wires electrically connected to the pair of clock pins and the M pairs of data pins respectively.

16. The structure as claimed in claim 15, wherein the cable is directly connected to an MIPI camera, the M data pins are configured as high-speed data transmission lines, and the plurality of self-defined pins are configured so that they can only be connected in series with another connection device along a specific direction.

17. The structure as claimed in claim 14, wherein:
the plurality of self-defined pins further include a total number of L general-purpose input/output pins, and the L is equal to 1 or 2; and
the structure further includes an adapter board having an FPC/FFC connection portion, a USB Type-C connection portion and an adapter circuit connected between the FPC/FFC connection portion and the USB Type-C connection portion.

18. The structure as claimed in claim 17, wherein:
the FPC/FFC connection portion is configured to receive or transmit the MIPI camera image signal via an FPC/FFC connector; and
the USB Type-C connection portion is configured to receive or transmit the MIPI camera image signal via the adapter circuit.

19. The structure as claimed in claim 15, wherein the cable has a wire core and an outer cover, and the wire core is selected from at least one of a tinned copper wire, an ultra-fine coaxial wire and an oxygen-free copper core.

20. The structure as claimed in claim 19, wherein a layer of a polyethylene (PE) material is disposed between the wire and the outer cover, and the outer cover is formed of at least one of a polyvinyl chloride (PVC) and a polyurethane (PU).
